(19) United States
(12) Patent Application Publication
(10) Pub. No.: US 2002/0056347 A1
(43) Pub. Date: May 16, 2002

(54) Method and system for cutting integrated circuit packages

(76) Inventors: Ferdinand S. Signey, Baguio City (PH); Shirley L. Signey, Baguio City (PH); Reynaldo C. Javier, Baguio City (PH); Mary J. Javier, Baguio City (PH)

Correspondence Address: TEXAS INSTRUMENTS INCORPORATED, P O BOX 655474, M/S 3999, DALLAS, TX, 75265

(21) Appl. No.: 09/975,219

(22) Filed: Oct. 11, 2001

Related U.S. Application Data
(60) Provisional application No. 60/249,392, filed on Nov. 15, 2000.

(51) Int. Cl. B26D 3/00

(52) U.S. Cl. 83/53; 83/76.1; 83/177

(57) ABSTRACT

A method for cutting integrated circuit packages includes providing an integrated circuit package, and cutting the integrated circuit package with a water jet.

### TECHNICAL FIELD OF THE INVENTION

This invention relates generally to the field of integrated circuits and, more specifically, to a method and system for cutting integrated circuit packages.

### BACKGROUND OF THE INVENTION

There are many different types of integrated circuit packages. For example, there are quad flat packages, dual in-line packages, and ball grid array packages. Some integrated circuit packages are mass produced on a contiguous material. As an example, ball grid array packages are sometimes produces on a sheet of material called polyimide, in which the polyimide has metal traces. If integrated circuit packages are mass produced, then they have to be singulated (i.e., cut into individual packages). This is normally done with a forming machine having a diamond blade saw. The diamond blade saw is also used extensively to cross-section integrated circuit packages so that the packages can be tested.

A cutting process using a diamond blade saw results in many problems. For example, higher tooling costs are realized due to premature tooling breakages. In addition, higher mechanical stresses result because of the diamond blade saw, which causes undesired microcracks and deformation in integrated circuit packages. Thermal deformation may also occur because of the heat produced during the cutting process. Also, if a chemical lubricant is used for the cutting process, the cutting process is potentially harmful to the environment. Another problem with the cutting process using a diamond blade saw is that a user cannot start cutting the integrated circuit package at any desired location.

### SUMMARY OF THE INVENTION

Because of the ever-increasing use of integrated circuits, manufacturers are continually searching for better and more economical ways of cutting integrated circuit packages. Therefore, a need has arisen for a new method and system for cutting integrated circuit packages.

In accordance with the present invention, a method and system for cutting integrated circuit packages is provided that addresses disadvantages and problems associated with previously developed methods and systems.

According to one embodiment of the invention, a method for cutting integrated circuit packages includes providing an integrated circuit package, and cutting the integrated circuit package with a water jet.

According to another embodiment of the invention, a system for cutting integrated circuit packages includes a computer operable to generate a predetermined cut pattern for the integrated circuit, and a water jet machining system operatively coupled to the computer. The water jet machining system is operable to generate a water jet with a suitable pressure for cutting the integrated circuit package into the predetermined cut pattern.

Embodiments of the invention provide numerous technical advantages. For example, a technical advantage of one embodiment of the present invention is the substantial reduction or elimination of premature tooling breakages, thus significantly reducing tooling costs. Another technical advantage of one embodiment of the present invention is that lower mechanical stress is encountered with the use of a water jet instead of a mechanical saw, thereby resulting in a cleaner, smoother cut. In addition, the water jet results in lower thermal deformation of the integrated circuit packages. An additional technical advantage of one embodiment of the present invention is that the water jet cutting process is environmentally sound because of the use of water instead of chemical lubricants typically used with a cutting blade. A further technical advantage of one embodiment of the present invention is that the cutting process can begin at any location on the integrated circuit packages.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIGS. 1A, 1B, and 1C are perspective views showing various embodiments of integrated circuit packages in accordance with the present invention;

FIG. 1D is a plan view showing a plurality of integrated circuit packages formed in a strip-type fashion on a substrate in accordance with one embodiment of the present invention;

FIG. 2 is a schematic diagram illustrating one embodiment of a system for cutting integrated circuit packages in accordance with the present invention; and

FIG. 3 is a flowchart demonstrating one method for cutting integrated circuit packages in accordance with the present invention.

### DETAILED DESCRIPTION OF THE INVENTION

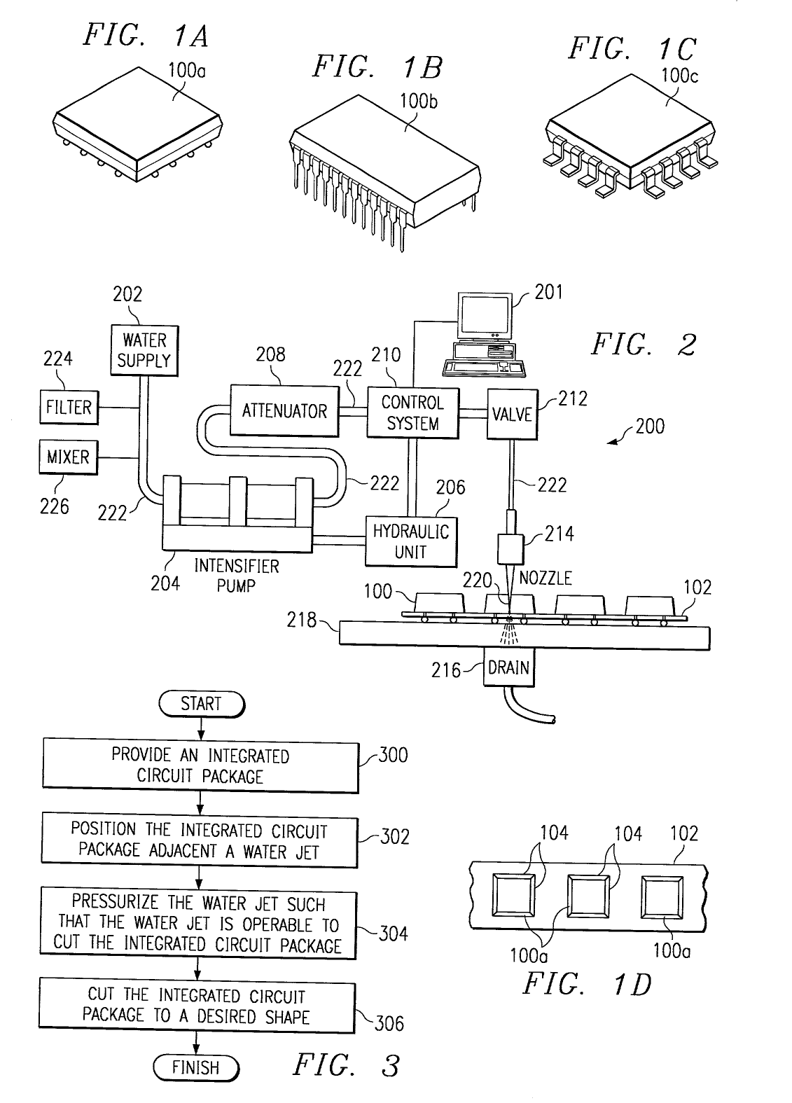

Embodiments of the present invention and their advantages are best understood by referring now to FIGS. 1A through 3 of the drawings, in which like numerals refer to like parts.

FIGS. 1A, 1B, and 1C are perspective views of various embodiments of integrated circuit packages in accordance with the present invention. FIG. 1A shows a ball grid array (“BGA”) package 100a, FIG. 1B shows a dual inline package (“DIP”) 100b, and FIG. 1C shows a quad flat package (“QFP”) 100c. Integrated circuit packages 100a, 100b, and 100c are used for many applications and many techniques are used to fabricate and test them. Some integrated circuit packages 100, such as BGA package 100a, are mass produced on a contiguous strip of material such as that shown in FIG. 1D.

FIG. 1D shows a plurality of BGA packages 100a formed in a strip-type fashion on a substrate 102, which may be, for example, a polyimide strip. BGA packages 100a, or other integrated circuit packages, such as DIP 100b and QFP 100c, may also be formed in other ways, such as in a ganged-type fashion. BGA packages 100a have edges 104, which is where BGA packages 100a are cut during a singulation process. A singulation process is used where integrated circuit packages 100 are mass produced, such as that shown in FIG. 1D. The singulation process is typically performed with a forming machine having a diamond blade saw. A forming machine with a diamond blade saw is also used for cross-sectioning integrated circuit packages for testing. Cross-sectioning means that an integrated circuit package is cut such that an interior portion of the integrated circuit package is accessible for testing. A cutting process with a diamond blade saw results in many problems, such as higher tooling costs because of premature tooling breakages, higher mechanical and thermal deformations of integrated circuit packages, and less dimensional precision and accuracy, in addition to being environmentally unfriendly. The present invention addresses these problems, and others, by utilizing a water jet machining system 200 as shown in FIG. 2.

FIG. 2 is a schematic diagram illustrating one embodiment of water jet machining process 200 for cutting integrated circuit packages in accordance with the present invention. One example of water jet machining system 200 is the Omni Jet® from Jet Edge®. Water jet machining system 200 includes a water supply 202, an intensifier pump 204 operatively coupled to water supply 202, a hydraulic unit 206 operatively coupled to intensifier pump 204, an attenuator 208 operatively coupled to intensifier pump 204, a control system 210 operatively coupled to attenuator 208, a computer 201 operatively coupled to control system 210, a valve 212 operatively coupled to control system 210, a nozzle 214 operatively coupled to valve 212, and a conduit 222 that transports water from water supply 202 to nozzle 214 so that the water is discharged as a waterjet 220.

Water jet machining system 200 may have other components, or fewer components, than that shown in FIG. 2. For example, water jet machining system 200 may include a workpiece table 218, a drain 216 operable to drain off the used water, a filter 224 coupled to conduit 222 for removing unwanted particles or contaminants in the water, and a mixer 226 operable to add abrasive particles to the water. Integrated circuit packages 100 are also shown in FIG. 2 adjacent workpiece table 218 with water jet 220 proximate one of integrated circuit packages 100. Water jet 220 is used to cut integrated circuit packages 100 in any suitable manner.

Water supply 202 may be any suitable type of water supply, such as a container or vessel that holds water. Before water from water supply 202 enters intensifier pump 204, the water may be filtered by filter 224 and may be combined with abrasive particles by passing the water through mixer 226. As discussed above, filter 224 removes unwanted particles or contaminants in the water, and abrasive particles from mixer 226 is used to increase the cutting capabilities of water jet 220. Abrasive particles may be such things as silica or garnet.

Intensifier pump 204 is any suitable size pump. Intensifier pump 204 is used to draw water from water supply 202, pressurize the water to any desired pressure, and send the water to attenuator 208 through conduit 222. Intensifier pump 204 is normally a high horsepower pump because the water needs to be pressurized to a high enough pressure so that water jet 220 may cut integrated circuit packages 100 in an efficient manner. Only one intensifier pump 204 is shown in FIG. 2; however, more than one may be utilized. Intensifier pump 204 is controlled by hydraulic unit 206, which may be any suitable type of hydraulic equipment that is coupled to intensifier pump 204 with hydraulic hoses.

Attenuator 208 dampens water pressure fluctuations created by the reciprocating motion of intensifier pump 204 to deliver a steady stream of high pressure water down to nozzle 214. Attenuator 208 may be any suitable size attenuator, and there may be more than one attenuator 208 depending on the cutting application.

Control system 210 is any suitable type of control system used to control the functioning of water jet machining system 200. For example, control system 210 may have the ability to turn intensifier pump 204 on or off, to control valve 212 by, for example, increasing flow, decreasing flow, or cutting off flow, or to direct either nozzle 214 or workpiece table 218. Control system 210 may comprise any number of elements, such as transducers, sensors, servomotors, gears, levers, and valves. Control system 210 may be coupled to computer 201 for automation purposes.

Computer 201 may be any suitable type of computer with a memory and a processor operable to store and execute software, such as CNC software or computer-aided manufacturing (“CAM”) software. Computer 201 communicates with control system 210 for the purpose of automating water jet machining process 200. The memory of computer 201 may be random access memory, read only memory, CD-ROM, removable memory devices, or any other suitable devices that allow storage and/or retrieval of data. The processor of computer 201 may comprise any suitable type of processing unit associated with an operating system that executes logic. One of the functions of the processor is to receive software from the memory and to execute this software in accordance with the parameters of the cutting operation. The software may be any suitable type of CNC or CAM software currently known or to be developed in the future.

Valve 212 is any suitable type of control valve used to control the flow of water that enters nozzle 214.

Nozzle 214 may be any suitable shape or configuration, and may have any suitable outlet diameter depending on what type of cut is desired. In one embodiment, the diameter of nozzle 214 is approximately 0.001 inches. There may also be more than one nozzle 214 if a user desires to make multiple cuts simultaneously. In one embodiment, nozzle 214 is formed from a jewel, such as a sapphire, a diamond, or a ruby; however, other types of materials may be used for nozzle 214. Depending on the cutting process parameters, the outlet of nozzle 214 is placed a predetermined distance away from integrated circuit package 100.

Water jet 220 is discharged from nozzle 214 and cuts integrated circuit package 100 in a predetermined cut pattern. The used water may be captured by drain 216. The pressure of water jet 220 varies, depending on what type of integrated circuit package 100 is being cut and what type of cut is desired. In one embodiment, the water pressure is between approximately 500 psi and approximately 2500 psi. Used water can be recycled and used again, thereby resulting in one technical advantage of the present invention. In addition, water is environmentally sound, which results in another technical advantage of the present invention.

FIG. 3 is a flowchart demonstrating one method for cutting integrated circuit packages 100 in accordance with the present invention. Integrated circuit package 100 is provided at step 300. Integrated circuit package 100 is any suitable type of integrated circuit package, such as BGA package 100a, DIP 100b, or QFP 100c. Integrated circuit packages 100 may also be fabricated on a substrate 102 as described above in conjunction with FIG. 1D.

Integrated circuit package 100 is positioned adjacent water jet 220 at step 302 (see FIG. 2). Water jet 220 is pressurized at step 304, such that water jet 220 is operable to cut integrated circuit package 100. In one embodiment, the water pressure is between approximately 500 psi and approximately 2500 psi. Water pressure, nozzle diameter, and other parameters are adjusted based on the type of integrated circuit package 100 being cut. Integrated circuit package 100 is then cut to a desired shape at step 306. In one embodiment, step 306 includes cutting a plurality of integrated circuit packages 100 by directing water jet 220 along edges 104 for the purpose of obtaining individual integrated circuit packages 100 that were mass produced in a strip or ganged-type fashion. In another embodiment, step 306 includes cutting integrated circuit package 100 such that an interior portion of integrated circuit package 100 is accessible for testing.

Although embodiments of the invention and their advantages are described in detail, a person skilled in the art could make various alternations, additions, and omissions without departing from the spirit and scope of the present invention as defined by the appended claims.

What is claimed is:

1. A method for cutting integrated circuit packages, comprising:
providing an integrated circuit package; and
cutting the integrated circuit package with a water jet.

2. The method of claim 1, wherein cutting the integrated circuit package with a water jet comprises:
positioning the integrated circuit package adjacent a water jet;
pressurizing the water jet such that the water jet is operable to cut the integrated circuit package; and
cutting the integrated circuit package to a predetermined shape.

3. The method of claim 1, wherein providing an integrated circuit package comprises providing a ball grid array package.

4. The method of claim 1, wherein cutting the integrated circuit package with a water jet comprises cutting the integrated circuit package with a water jet having a plurality of abrasive particles.

5. The method of claim 2, wherein pressurizing the water jet comprises pressurizing the water jet to a pressure between approximately 500 psi and approximately 2500 psi.

6. The method of claim 1, wherein cutting the integrated circuit package with a water jet comprises cutting a plurality of integrated circuit packages by directing the water jet along at least one of a plurality of edges of the integrated circuit packages.

7. The method of claim 1, wherein cutting the integrated circuit package with a water jet comprises cutting the integrated circuit package such that an interior portion of the integrated circuit package is accessible for testing.

8. A method for cutting integrated circuit packages, comprising:
providing an integrated circuit package;
positioning the integrated circuit package adjacent a water jet;
pressurizing the water jet such that the water jet is operable to cut the integrated circuit package; and
cutting the integrated circuit package to a desired shape.

9. The method of claim 8, wherein providing an integrated circuit package comprises providing a ball grid array package.

10. The method of claim 8, wherein cutting the integrated circuit package to a desired shape comprises cutting the integrated circuit package with a water jet having a plurality of abrasive particles.

11. The method of claim 8, wherein pressurizing the water jet comprises pressurizing the water jet to a pressure between approximately 500 psi and approximately 2500 psi.

12. The method of claim 8, wherein cutting the integrated circuit package to a desired shape comprises cutting a plurality of integrated circuit packages by directing the water jet along at least one of a plurality of edges of the integrated circuit packages.

13. The method of claim 8, wherein cutting the integrated circuit package to a desired shape comprises cutting the integrated circuit package such that an interior portion of the integrated circuit package is accessible for testing.

14. A system for cutting an integrated circuit package, comprising:
a computer operable to generate a predetermined cut pattern for the integrated circuit; and
a water jet machining system operatively coupled to the computer and operable to generate a water jet with a suitable pressure for cutting the integrated circuit package into the predetermined cut pattern.

15. The system of claim 14, wherein the water jet machining system comprises:
a water supply;
an intensifier pump operatively coupled to the water supply and operable to pump water through a conduit;
a hydraulic unit operatively coupled to the intensifier pump;
an attenuator operatively coupled to the water and operable to dampen pressure fluctuations of the water in the conduit;
a valve coupled to the conduit and operable to control the flow of the water; and
a nozzle coupled to conduit operable to direct the water along the predetermined cut pattern.

16. The system of claim 14, wherein the integrated circuit package is a ball grid array package.

17. The system of claim 14, wherein the water jet comprises a plurality of abrasive particles.

18. The system of claim 14, wherein the suitable pressure is between approximately 500 psi and approximately 2500 psi.

19. The system of claim 14, wherein the predetermined cut pattern comprises a plurality of edges of the integrated circuit package, wherein the integrated circuit package is formed on a polyimide strip.

20. The system of claim 14, wherein the predetermined cut pattern comprises a pattern through an interior portion of the integrated circuit package such that the interior portion is accessible for testing.
